(19) United States
(12) Patent Application Publication
(10) Pub. No.: US 2009/0265580 A1
(43) Pub. Date: Oct. 22, 2009

(54) ERROR DETECTION METHOD FOR A COMPUTER SYSTEM, AND ELECTRONIC DEVICE

(75) Inventors: Yin-Chieh Lee, Taipei Hsien (TW); Hsu-Ming Lee, Taipei Hsien (TW); Shu-Lin Chao, Taipei Hsien (TW); Chun-Lin Lu, Taipei Hsien (TW)

Correspondence Address: CHOATE, HALL & STEWART LLP, TWO INTERNATIONAL PLACE, BOSTON, MA, 02110, US

(73) Assignee: Wistron Corporation, Taipei Hsien (TW)

(21) Appl. No.: 12/354,315

(22) Filed: Jan. 15, 2009

(30) Foreign Application Priority Data
Apr. 22, 2008 (TW) 097114626

(51) Int. Cl. G06F 11/273

(52) U.S. Cl. 714/27; 714/E11.17

(57) ABSTRACT

An error detection method for a computer system includes the steps of: enabling an error-detecting computer to communicate with a keyboard controller of a computer-under-test through a communication interface; enabling the error-detecting computer to issue an error detection command to the keyboard controller that causes the keyboard controller to issue a request command to the basic input/output system (BIOS) of the computer-under-test; enabling the BIOS, in response to the request command, to access the keyboard controller and determine hardware status information that is being requested from the error detection command, and subsequently, to obtain the hardware status information of the computer-under-test, and to transmit the hardware status information to the keyboard controller; and enabling the keyboard controller to transmit the hardware status information received thereby to the error-detecting computer through the communication interface.

### CROSS-REFERENCE TO RELATED APPLICATION

This application claims priority of Taiwanese application no. 097114626, filed on Apr. 22, 2008, which is incorporated herein by reference in its entirety.

### BACKGROUND OF THE INVENTION

1. Field of the Invention

This invention relates to an error detection method for a computer system, more particularly to an error detection method for a computer in an initial stage of development.

2. Description of the Related Art

A notebook computer in an initial stage of development often fails to boot normally. To find the cause of boot failure, it is necessary to perform error detection on a boot process of the notebook computer, which currently involves using a Low Pin Count (LPC) or a Peripheral Component Interconnect Express (PCIe) error detection card to read and display a status of the boot process.

However, the above-described error detection method only displays a last successfully executed portion of the boot process of the notebook computer, and therefore does not provide a precise indication of a point in the boot process at which the error occurs. Consequently, the error must be found through a process of trial and error, making the current error detection method inefficient.

### SUMMARY OF THE INVENTION

Therefore, an object of the invention is to provide an error detection method for a computer system that is efficient.

According to one aspect of the invention, there is provided an error detection method for a computer system, comprising:

enabling an error-detecting computer to communicate with a keyboard controller of a computer-under-test through a communication interface;

enabling the error-detecting computer to issue an error detection command to the keyboard controller that causes the keyboard controller to issue a request command to the basic input/output system (BIOS) of the computer-under-test;

enabling the BIOS, in response to the request command, to access the keyboard controller and determine hardware status information that is being requested from the error detection command, and subsequently, to obtain the hardware status information of the computer-under-test, and to transmit the hardware status information to the keyboard controller; and

enabling the keyboard controller to transmit the hardware status information received thereby to the error-detecting computer through the communication interface.

According to another aspect of the invention, there is provided an electronic device that can be caused by an error-detecting computer to perform system error detection. The electronic device comprises a basic input/output system (BIOS) and a keyboard controller. The keyboard controller is coupled to the BIOS, and is capable of communicating with the error-detecting computer through a communication interface, receiving from the error-detecting computer an error detection command, and issuing a request command to the BIOS in response to the error detection command.

The BIOS, in response to the request command, accesses the keyboard controller and determines hardware status information that is being requested from the error detection command, and subsequently obtains the hardware status information of the electronic device, and transmits the hardware status information to the keyboard controller. The keyboard controller transmits the hardware status information received thereby to the error-detecting computer through the communication interface.

In an embodiment of the invention, the communication interface is a Universal Asynchronous Receiver/Transmitter (UART) communication interface.

In an embodiment of the invention, the request command is a System Management Interrupt (SMI) command.

In an embodiment of the invention, the BIOS accesses the keyboard controller through a Low Pin Count (LPC) interface.

In an embodiment of the invention, the BIOS transmits the hardware status information to the keyboard controller through the LPC interface.

In an embodiment of the invention, the error detection command is an RS232 command conforming to a UART communication protocol.

In an embodiment of the invention, the electronic device is a notebook computer.

In the error detection method for a computer system according to the invention, the error-detecting computer, being provided with the hardware status information of the computer-under-test (electronic device), can determine easily a point in a boot process of the computer-under-test (electronic device) at which an error occurs. Time spent searching for the error is thus reduced, and the error detection is made more efficient. Moreover, hardware of the computer-under-test (electronic device) does not need to be altered to accommodate the error detection method of the invention, since through low-level access provided by the keyboard controller, the hardware information status can be obtained from the BIOS and used for purposes of error detect ion and system analysis.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic block diagram to illustrate an embodiment of an error detection method for a computer system; and

FIG. 2 is a flow chart illustrating an embodiment of an error detection method.

### DETAILED DESCRIPTION

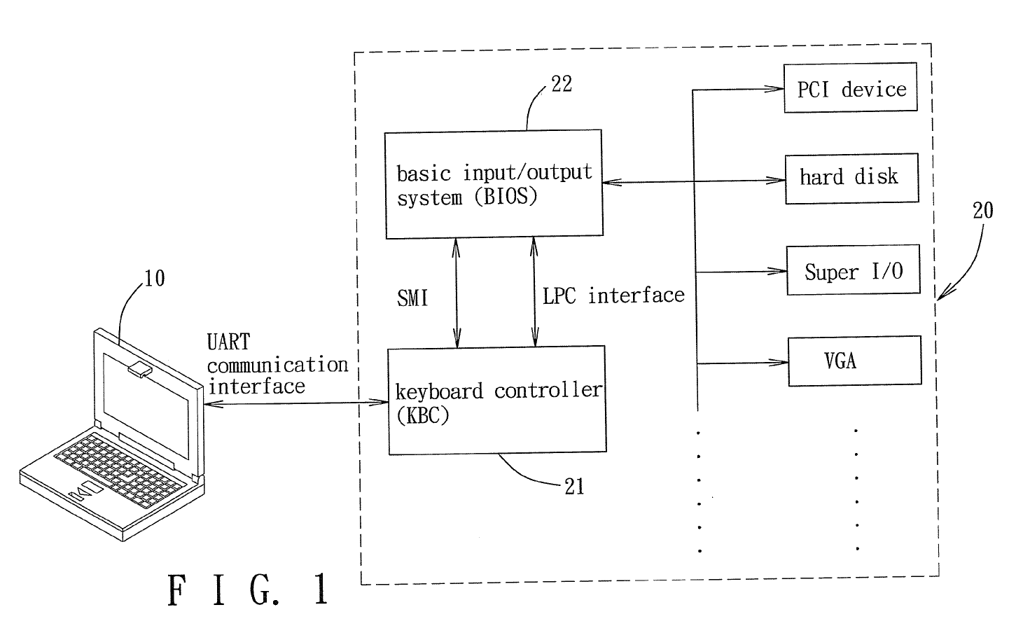

FIG. 1 illustrates an embodiment of an error detection method that is performed on a computer system in an initial stage of development. In this embodiment, an error-detecting computer 10 obtains internal information from the computer system or computer-under-test 20 in order to perform system error detection on the computer-under-test 20.

In some embodiments, the error-detecting computer 10 and the computer-under-test 20 are each provided with an RS232 compatible Universal Asynchronous Receiver/Transmitter (UART) port (which can be either wired or wireless). Through the UART communication interface established between the two UART ports, the error-detecting computer 10 can issue commands and transmit data to a keyboard controller 21 of the computer-under-test 20.

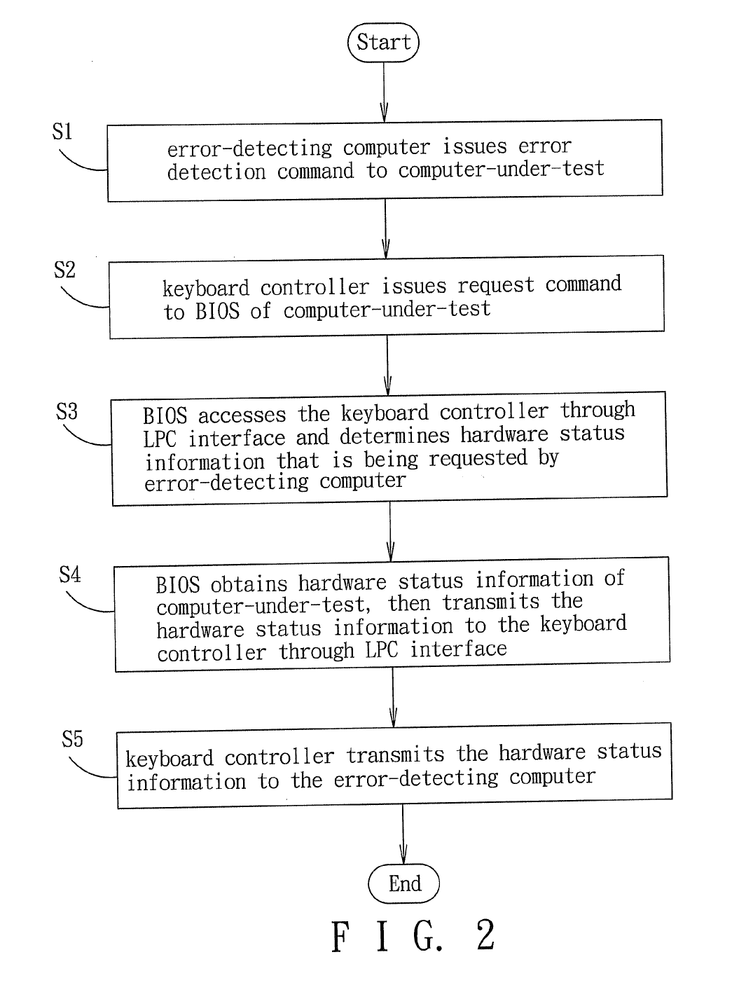

Referring to FIG. 2, a flow chart of an embodiment of an error detection method for a computer system is shown to comprise the following steps:

In step S1, the error-detecting computer 10 issues an error detection command to the keyboard controller 21 of the computer-under-test 20 through the UART communication interface. In this embodiment, the error detection command is an RS232 command conforming to a UART communication protocol, and is generated by an application program of the error-detecting computer 10. The application program can be a commonly known program, such as Microsoft HyperTerminal, or any other proprietary program, provided that the error detection command thus generated is one that can be received by the keyboard controller 21 and can be read by a basic input/output system (BIOS, described below) 22 of the computer-under-test 20.

The BIOS resides in a read-only memory (ROM), an Erasable Programmable ROM (EPROM), or a Flash ROM of a computer, and is used during startup of the computer to identify and initialize component hardware, including peripheral devices. The BIOS is loaded into a processor for performing startup procedures upon activation of the computer.

In step S2, on receiving the error detection command issued from the error-detecting computer 10, the keyboard controller 21 issues a request command to the BIOS 22 of the computer-under-test 20. In this embodiment, the request command is a System Management Interrupt (SMI) command. However, the type of command issued is not limited to what is described above, and can be a General Purpose Input/Output (GPI/0) command or any command that can be used to request hardware status information from the BIOS 22.

In step S3, the BIOS 22, in response to the request command issued by the keyboard controller 21, accesses the keyboard controller 21 through a Low Pin Count (LPC) interface (through port 62/66, for example) and determines from the content of the error detection command temporarily stored in the keyboard controller 21 hardware status information that is being requested by the error-detecting computer 10, such as status information of a Peripheral Component Interconnect (PCI) device, a hard disk, a super I/O, or a Video Graphics Array (VGA).

Subsequently, in step S4, the BIOS 22 obtains the hardware status information of the computer-under-test 20, and transmits the hardware status information to the keyboard controller 21 through the LPC interface.

In step S5, the keyboard controller 21 transmits the hardware status information received thereby to the error-detecting computer 10 through the DART communication interface.

In embodiments of the error detection method for a computer system, the error-detecting computer 10, being provided with the hardware status information of the computer-under-test 20, can determine easily a point in a boot process of the computer-under-test 20 at which an error occurs. Time spent searching for the error is thus reduced, and the error detection is made more efficient. Moreover, in this embodiment, hardware of the computer-under-test 20 does not need to be altered to accommodate the error detection method, since through low-level access provided by the keyboard controller 21, the hardware information status can be obtained from the BIOS 22 and used for purposes of error detection and system analysis.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. An error detection method for a computer system, comprising:
enabling an error-detecting computer to communicate with a keyboard controller of a computer-under-test through a communication interface;
enabling the error-detecting computer to issue an error detection command to the keyboard controller that causes the keyboard controller to issue a request command to the basic input/output system (BIOS) of the computer-under-test;
enabling the BIOS, in response to the request command, to access the keyboard controller and determine hardware status information that is being requested from the error detection command, and subsequently, to obtain the hardware status information of the computer-under-test, and to transmit the hardware status information to the keyboard controller; and
enabling the keyboard controller to transmit the hardware status information received thereby to the error-detecting computer through the communication interface.

2. The error detection method for a computer system as claimed in claim 1, wherein the communication interface is a Universal Asynchronous Receiver/Transmitter (UART) communication interface.

3. The error detection method for a computer system as claimed in claim 1, wherein the request command is a System Management Interrupt (SMI) command.

4. The error detection method for a computer system as claimed in claim 1, wherein the BIOS accesses the keyboard controller through a Low Pin Count (LPC) interface.

5. The error detection method for a computer system as claimed in claim 4, wherein the BIOS transmits the hardware status information to the keyboard controller through the LPC interface.

6. The error detection method for a computer system as claimed in claim 2, wherein the error detection command is an RS232 command conforming to a DART communication protocol, and is generated by an application program of the error-detecting computer.

7. An electronic device that can be caused by an error-detecting computer to perform system error detection, comprising:
a basic input/output system (BIOS); and
a keyboard controller coupled to said BIOS, and capable of communicating with the error-detecting computer through a communication interface, receiving from the error-detecting computer an error detection command, and issuing a request command to said BIOS in response to the error detection command;
wherein said BIOS, in response to the request command, accesses said keyboard controller and determines hardware status information that is being requested from the error detection command, and subsequently obtains the hardware status information of the electronic device, and transmits the hardware status information to said keyboard controller; and said keyboard controller transmits the hardware status information received thereby to the error-detecting computer through said communication interface.

8. The electronic device as claimed in claim 7, wherein said communication interface is a Universal Asynchronous Receiver/Transmitter (UART) communication interface.

9. The electronic device as claimed in claim 7, wherein the request command is a System Management Interrupt (SMI) command.

10. The electronic device as claimed in claim 7, wherein said BIOS accesses said keyboard controller through a Low Pin Count (LPC) interface.

11. The electronic device as claimed in claim 10, wherein said BIOS transmits the hardware status information to said keyboard controller through said LPC interface.

12. The electronic device as claimed in claim 8, wherein the error detection command is an RS232 command conforming to a UART communication protocol.

13. The electronic device as claimed in claim 7, wherein said electronic device is a notebook computer.
